(19) United States
(12) Patent Application Publication
(10) Pub. No.: US 2022/0397836 A1
(43) Pub. Date: Dec. 15, 2022

(54) TONER

(71) Applicant: CANON KABUSHIKI KAISHA, Tokyo (JP)

(72) Inventors: Takayuki Toyoda, Shizuoka (JP); Naoya Isono, Shizuoka (JP); Hirofumi Kyuushima, Tokyo (JP); Masao Suzuki, Kanagawa (JP); Tomoya Nagaoka, Tokyo (JP)

(21) Appl. No.: 17/804,883

(22) Filed: Jun. 1, 2022

(30) Foreign Application Priority Data
Jun. 8, 2021 (JP) 2021-096099
Jan. 26, 2022 (JP) 2022-010387

(51) Int. Cl. G03G 9/087; G03G 9/097; G03G 9/093; G03G 9/08

(52) U.S. Cl. CPC G03G 9/08755; G03G 9/09733; G03G 9/09708; G03G 9/08711; G03G 9/09371; G03G 9/09321; G03G 9/0802

(57) ABSTRACT

A toner comprising a toner particle comprising a binder resin, wherein the toner particle further comprises: a compound represented by R¹—[OCH₂CH₂]ₙ—OH, where, R¹ represents a linear or branched alkyl group having 8 to 22 carbon atoms, and n is an integer of 1 to 3; and at least one polyvalent element selected from the group consisting of magnesium, calcium, aluminum, boron and iron, and a content of the polyvalent element in the toner is 100 mass ppm to 5000 mass ppm.

### BACKGROUND OF THE INVENTION

### Field of the Invention

The present disclosure relates to a toner used in a recording method that relies on such as an electrophotographic method.

### Description of the Related Art

Speed and energy savings in image forming apparatuses, such as copiers and printers, have steadily improved in recent years. To accommodate these improvements there is an increasing demand for toners that exhibit yet better low-temperature fixability. For the purpose of improving the low-temperature fixability of the toner, there are methods including lowering the melting point of toner. However, simply lowering the melting point of the toner lowers a storage stability of the toner. There is also an increasing demand for higher image quality, and a requirement of providing sharp high-gloss images to meet the demand for high-quality image formation, for instance in photographic images. In order to achieve a high-gloss image, the surface of the image has to be made smooth by causing the toner to melt thoroughly; however, in such cases, there has been a problem that hot offset are likely to occur.

As a method for preventing hot offset, Japanese Patent Application Publication No. H08-160660 discloses a method that involves arranging a release agent in the vicinity of the toner surface, and instantly exposing the release agent from the toner during fixing, to prevent melt adhesion onto a fixing member.

In Japanese Patent Application Publication No. 2016-218208, meanwhile, heat resistance and crush resistance are improved through addition of a polyvalent metal salt compound.

### SUMMARY OF THE INVENTION

Although an effect of suppressing the occurrence of hot offset to certain extent was elicited by the toner disclosed in Japanese Patent Application Publication No. H08-160660, there was a problem in the occurrence of melt adhesion triggered by the release agent, during stirring in a developing machine, with the charge amount of the toner tending to decrease as a result of the adhesion of the release agent onto a developing member. Also, the toner disclosed in Japanese Patent Application Publication No. 2016-218208 was problematic in that although metal crosslinking of a binder resin through addition of a salt of a polyvalent metal resulted in improved crush resistance and heat resistance, however, gloss was lower on account of crosslinked portions, which gave rise to gloss unevenness. The present disclosure provides a toner exhibiting excellent low-temperature fixability, hot offset resistance, storage stability and developing performance, and in which the occurrence of gloss unevenness is suppressed.

The present disclosure relates to a toner comprising a toner particle comprising a binder resin,

wherein

the toner particle further comprises:
a compound represented by Formula (1) below:

R¹—[OCH₂CH₂]ₙ—OH (1)
where, in Formula (1), R¹ represents a linear or branched alkyl group having 8 to 22 carbon atoms, and n is an integer of 1 to 3; and
at least one polyvalent element selected from the group consisting of magnesium, calcium, aluminum, boron and iron, and

a content of the polyvalent element in the toner is 100 mass ppm to 5000 mass ppm.

The present disclosure allows providing a toner exhibiting excellent low-temperature fixability, hot offset resistance, storage stability and developing performance, and in which the occurrence of gloss unevenness is suppressed.

Further features of the present disclosure will become apparent from the following description of exemplary embodiments.

### DESCRIPTION OF THE EMBODIMENTS

Embodiments will now be explained in detail, but the present disclosure is in no way limited to the explanations given below. Unless otherwise specified, the description of “from XX to YY” or “XX to YY” indicating a numerical range means a numerical range including a lower limit and an upper limit which are end points. When a numerical range is described step by step, the upper and lower limits of each numerical range can be arbitrarily combined.

The present disclosure relates to a toner comprising a toner particle comprising a binder resin,

wherein

the toner particle further comprises:
a compound represented by Formula (1) below:

R¹—[OCH₂CH₂]ₙ—OH (1)
where, in Formula (1), R¹ represents a linear or branched alkyl group having 8 to 22 carbon atoms, and n is an integer of 1 to 3; and
at least one polyvalent element selected from the group consisting of magnesium, calcium, aluminum, boron and iron, and

a content of the polyvalent element in the toner is 100 mass ppm to 5000 mass ppm.

The inventors found that a toner exhibiting excellent low-temperature fixability, hot offset resistance, storage stability and developing performance, and in which the occurrence of gloss unevenness is suppressed, can be provided by using a toner having the above features. The inventors surmise the following concerning the underlying reasons for this.

The toner of the present disclosure comprises from 100 mass ppm to 5000 mass ppm of a specific polyvalent element; as a result, a crosslinked structure with the binder resin is formed by ions generated from the polyvalent element or ions comprising the polyvalent element, even when using a binder resin of low melting point and excellent in low-temperature fixability, and the toner exhibits thus improved storage stability, hot offset resistance and developing performance. It is surmised that hot offset is suppressed and a uniform high-gloss image is obtained in which the occurrence of gloss unevenness in a fixed image is suppressed, by virtue of the fact that the compound represented by Formula (1) forms a crosslinked structure also with ions generated from the polyvalent element or with ions comprising the polyvalent element, at the time of fixing and melting, and thanks to the fact that the crosslinked structure in the binder resin is made uniform and the image surface is smoothed.

The constituent requirements of the present disclosure will be described in detail below.

The toner of the present disclosure contains at least one polyvalent element selected from the group consisting of magnesium, calcium, aluminum, boron and iron, in the toner particle. A content of the polyvalent element in the toner is 100 mass ppm to 5000 mass ppm. Preferably, the content of the polyvalent element in the toner is 150 mass ppm to 2500 mass ppm. When the content of the polyvalent element in the toner is 100 mass ppm or higher, the occurrence of gloss unevenness is suppressed, and storage stability is improved for instance in terms of making the occurrence of blocking unlikelier. On the other hand, when the content of the polyvalent element in the toner is 5000 mass ppm or lower, the occurrence of gloss unevenness can be suppressed, and excellent low-temperature fixability can be achieved.

The toner particle comprises at least one element selected from the group consisting of magnesium, calcium, aluminum, boron and iron, as the polyvalent element. Further, the toner particle may comprise a compound that comprises at least one polyvalent element selected from the group consisting of magnesium, calcium, aluminum, boron and iron. The polyvalent element can generate ions for crosslinking during the toner production process and during fixing and melting. Thereby, in the production process of the toner particle, or at the time of fixing and melting the toner, the toner particle may comprise a crosslinked product of ions generated from the polyvalent element or ions comprising the polyvalent element, and at least one selected from the group consisting of the compound represented by Formula (1) and a binder resin. Among the foregoing, the polyvalent element is preferably at least one selected from the group consisting of aluminum, boron and iron. More preferably, the polyvalent element is boron. Herein aluminum, boron and iron have high valences, and thus the generated ionic valence is also high, and the density of the crosslinked structure with the compound represented by Formula (1) or with the binder resin can be increased, hot offset resistance can be further improved, and the occurrence of gloss unevenness can be further suppressed. In particular, the ionic radius from boron is small, and boron reacts immediately with water in a normal environment, giving rise to borate ions B(OH)₄⁻; in a case therefore where the polyvalent element is boron, crosslinking density becomes higher, hot offset resistance is further improved, and the occurrence of gloss unevenness can be further suppressed.

The method for incorporating at least one polyvalent element selected from the group consisting of magnesium, calcium, aluminum, boron and iron into the toner particle is not particularly limited. For instance, the compound containing a polyvalent element may be added in the production process of the toner particle. Simple concrete examples include a method that involves direct addition of the compound containing a polyvalent element to a composition for a toner particle such as a binder resin; alternatively, in the case of production of the toner particle in an aqueous medium, a method that involves addition of the compound containing a polyvalent element, in the form of a pH adjusting agent, flocculant, stabilizer or the like. From the viewpoint of facilitating the adjustment of the content of the polyvalent element in the toner, preferred examples include a method of direct addition to the composition for a toner particle, and a method of addition in the form of a flocculant. Examples of the compound containing a polyvalent element include borax, aluminum chloride, polyaluminum chloride, aluminum hydroxide, aluminum sulfate, magnesium chloride, magnesium hydroxide, calcium chloride, calcium hydroxide and polysilica iron.

The use of these compounds makes it easy to adjust the content of the polyvalent element in the toner, the type of the polyvalent element, and the like. The addition amount of the compound containing a polyvalent element is preferably such that the content of the polyvalent element in the toner is from 100 mass ppm to 5000 mass ppm, and is more preferably an addition amount such that the content of the polyvalent element in the toner is from 150 mass ppm to 2500 mass ppm.

The toner particle comprises a compound represented by Formula (1) below. (1) R¹—[OCH₂CH₂]ₙ—OH. In Formula (1), R¹ represents a linear or branched alkyl group having 8 to 22 carbon atoms. Compatibility with the binder resin can be improved, the image surface can be smoothed, and gloss unevenness in the fixed image can be suppressed by virtue of the fact that R¹ is a linear or branched alkyl group having 8 to 22 carbon atoms. Moreover, hot offset resistance, storage stability and chargeability can be improved. In Formula (1), R¹ is preferably a linear alkyl group. The number of carbon atoms of R¹ is preferably 8 or more, more preferably 10 or more, and yet more preferably 12 or more. Further, the number of carbon atoms of R¹ is preferably 22 or fewer, more preferably 14 or fewer. In Formula (1), n is an integer of 1 to 3. By virtue of the fact that n lies within the above numerical value range, compatibility with the binder resin is improved, a crosslinked structure with ions generated by the polyvalent element or ions comprising the polyvalent element is formed readily, the crosslinked structure in the binder resin is made uniform, and the image surface is smoothed, as a result of which the occurrence of gloss unevenness in the fixed image can be suppressed, while maintaining hot offset resistance, storage stability and chargeability. Preferably, n is 1 herein.

A content of the compound represented by Formula (1) in the toner is preferably 2 mass ppm to 630 mass ppm, more preferably 5 mass ppm to 500 mass ppm, and yet more preferably 10 mass ppm to 400 mass ppm. By setting the content of the compound represented by Formula (1) to lie in the above numerical range, it becomes possible to further suppress the occurrence of gloss unevenness in the fixed image, while maintaining hot offset resistance, storage stability and chargeability.

A ratio (A/B) of the number of moles A of the compound represented by Formula (1) and the number of moles B of the polyvalent element, comprised in the toner, is preferably 0.0003 to 0.1200, more preferably 0.0010 to 0.1000, yet more preferably 0.0010 to 0.0200, and particularly preferably 0.0015 to 0.0045. When the value of A/B is 0.0003 or higher, aggregation of the polyvalent elements during fixing is readily suppressed, and the occurrence of gloss unevenness at the time of fixing can be further suppressed. Through setting of A/B to be 0.1200 or lower, exudation of the compound represented by Formula (1) is readily suppressed, storage stability and chargeability are further improved, and a crosslinked structure of the compound represented by Formula (1) and ions generated from the polyvalent element or ions comprising the polyvalent element is formed properly, thanks to which hot offset resistance is further improved.

Binder Resin

A known resin for toner may be used, without particular limitations, as the binder resin. From the viewpoint of forming a crosslinked structure with ions comprising a polyvalent element or ions generated from the polyvalent element and a binder resin, the binder resin preferably has a functional group such as a carboxy group, a carbonyl group or a hydroxyl group. Examples include specifically polyester resins; and styrene acrylic resins such as styrene-methyl acrylate copolymers, styrene-ethyl acrylate copolymers, styrene-butyl acrylate copolymers, styrene-octyl acrylate copolymers, styrene-dimethylaminoethylacrylate copolymers, styrene-methyl methacrylate copolymers, styrene-ethyl methacrylate copolymers, styrene-butyl methacrylate copolymers and styrene-dimethylaminoethyl methacrylate copolymers.

The binder resin preferably comprises a polyester resin from the viewpoint of ease of production of a resin exhibiting excellent low-temperature fixability and having a low melting point, and in terms of the formation of a crosslinked structure with ions comprising a polyvalent element or ions generated from the polyvalent element. Further, the polyester resin preferably comprises an amorphous polyester resin. A content of the polyester resin, in particular, an amorphous polyester resin, in the binder resin is preferably 50 mass % or higher. The upper limit of the content of the polyester resin in the binder resin is 100 mass % or lower, but is preferably 95 mass % or lower.

The polyester resin is obtained by polycondensation of a polyvalent carboxylic acid and a polyhydric alcohol. Examples of the polyvalent carboxylic acid include aliphatic dicarboxylic acids (for instance, oxalic acid, malonic acid, maleic acid, fumaric acid, citraconic acid, itaconic acid, glutaconic acid, succinic acid, alkenylsuccinic acid, adipic acid, sebacic acid, and the like), alicyclic dicarboxylic acids (for instance, cyclohexanedicarboxylic acid and the like), aromatic dicarboxylic acids (for instance, terephthalic acid, isophthalic acid, phthalic acid, naphthalenedicarboxylic acid and the like), as well as anhydrides of the foregoing. A trivalent or higher carboxylic acid having a crosslinked structure or a branched structure may be used, concomitantly with a dicarboxylic acid, as the above polyvalent carboxylic acid. Examples of the trivalent or higher carboxylic acid include trimellitic acid and pyromellitic acid, as well as anhydrides thereof, and the like. The polyvalent carboxylic acid may be used singly or in combinations of two or more types.

Examples of the polyhydric alcohol include aliphatic diols (for instance, ethylene glycol, diethylene glycol, triethylene glycol, propylene glycol, butanediol, hexanediol, neopentyl glycol, and the like), alicyclic diols (for instance, cyclohexanediol, cyclohexanedimethanol, hydrogenated bisphenol A, and the like), aromatic diols (for instance, alkylene oxide adducts of bisphenol A and the like), heterocyclic diols (for instance, spiroglycol and isosorbide, as well as alkylene oxide adducts thereof and the like). A trihydric or higher polyhydric alcohol having a crosslinked structure or a branched structure may be used, concomitantly with a diol, as the polyhydric alcohol. Examples of the trihydric or higher polyhydric alcohol include glycerin, trimethylolpropane, pentaerythritol and the like. The polyhydric alcohol may be used singly or in combinations of two or more types.

The amorphous polyester resin comprises a structural unit represented by Formula (2) in a content of preferably 5.0 mass % or lower. The lower limit of the content is 0.0 mass % or higher, but the content is preferably 0.0 mass %. Low-temperature fixability is readily improved in a case where the amorphous polyester resin comprises the structural unit represented by Formula (2) in a content of 5.0 mass % or lower. Also, a crosslinked structure is formed readily between the polyester resin and the ions comprising the polyvalent element or the ions generated from the polyvalent element, and hot offset resistance is further improved.

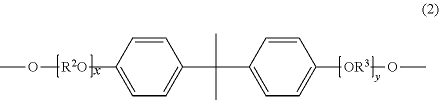

(In the Formula (2), R² and R³ each independently represent an ethylene group or a propylene group; x and y each independently represent the average addition mole number of alkylene oxide; and the value of the sum of x and y is 1 to 5.)

A content of the polyester resin or the amorphous polyester resin in the binder resin is preferably 50 mass % or higher, more preferably 60 mass % or higher, and yet more preferably 70 mass % or higher. When the content of the polyester resin or the amorphous polyester resin is 50 mass % or higher, a crosslinked structure is readily formed between the polyester resin and the ions comprising the polyvalent element or ions generated from the polyvalent element, and hot offset resistance is further improved. The weight-average molecular weight (Mw) of the polyester resin is preferably 20000 to 300000, more preferably 30000 to 200000, and yet more preferably 40000 to 100000.

The binder resin may contain various resins, so long as the effect of the present disclosure is not affected thereby. For instance, the resins below can be exemplified. Homopolymers of styrene and of substituted products thereof, such as polystyrene and polyvinyltoluene; styrenic copolymers such as styrene-propylene copolymers, styrene-vinyltoluene copolymers, styrene-vinylnaphthalene copolymers, styrene-vinylmethyl ether copolymers, styrene-vinylethyl ether copolymers, styrene-vinylmethyl ketone copolymers, styrene-butadiene copolymers, styrene-isoprene copolymers, styrene-maleic acid copolymers and styrene-maleate ester copolymers;

as well as polymethyl methacrylate, polybutyl methacrylate, polyvinyl acetate, polyethylene, polypropylene, polyvinyl butyral, silicone resins, crystalline polyester resins, polyamide resins, epoxy resins, polyacrylic resins, rosin, modified rosin, terpene resins, phenolic resins, aliphatic or alicyclic hydrocarbon resins, and aromatic petroleum resins. The foregoing may be used singly or in the form of mixtures thereof.

Colorant

The toner particle may contain a colorant. The colorant is not particularly limited, and for instance, the known colorants listed below can be used herein, singly or in combination.

Examples of black colorants include carbon black, and colorants that are color-matched to black using a yellow colorant, a magenta colorant and a cyan colorant.

Magenta coloring pigments can be exemplified by the following: C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, and 282; C.I. Pigment Violet 19; and C.I. Vat Red 1, 2, 10, 13, 15, 23, 29, and 35.

Magenta coloring dyes can be exemplified by the following: oil-soluble dyes such as C.I. Solvent Red 1, 3, 8, 23, 24, 25, 27, 30, 49, 81, 82, 83, 84, 100, 109, and 121; C.I. Disperse Red 9; C.I. Solvent Violet 8, 13, 14, 21, and 27; and C.I. Disperse Violet 1, and by basic dyes such as C.I. Basic Red 1, 2, 9, 12, 13, 14, 15, 17, 18, 22, 23, 24, 27, 29, 32, 34, 35, 36, 37, 38, 39, and 40 and C.I. Basic Violet 1, 3, 7, 10, 14, 15, 21, 25, 26, 27, and 28.

Cyan coloring pigments can be exemplified by the following: C.I. Pigment Blue 2, 3, 15:2, 15:3, 15:4, 16, and 17; C.I. Vat Blue 6; C.I. Acid Blue 45; and copper phthalocyanine pigments in which 1 to 5 phthalimidomethyl groups are substituted on the phthalocyanine skeleton.

Cyan coloring dyes can be exemplified by C.I. Solvent Blue 70.

Yellow coloring pigments can be exemplified by the following: C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185, and C.I. Vat Yellow 1, 3, and 20.

Yellow coloring dyes can be exemplified by C.I. Solvent Yellow 162.

The content of the colorant is preferably 3.0 mass % to 15.0 mass % relative to the toner particle.

Release Agent

The toner particle preferably contains a release agent from the viewpoint of separativeness. Examples of the wax include the following. Hydrocarbon waxes such as low molecular weight polyethylene, low molecular weight polypropylene, alkylene copolymers, microcrystalline wax, paraffin wax, Fischer-Tropsch wax, and the like; oxides of hydrocarbon waxes such as polyethylene oxide wax or block copolymers thereof; waxes including fatty acid esters such as carnauba wax as the main component; and partially or wholly deoxidized fatty acid esters such as deoxidized carnauba wax and the like.

Furthermore, the following can be mentioned. Saturated linear fatty acids such as palmitic acid, stearic acid, montanic acid, and the like; unsaturated fatty acids such as brassidic acid, eleostearic acid, parinaric acid, and the like; saturated alcohols such as melissyl alcohol, and the like; polyhydric alcohols such as sorbitol, and the like; esters of fatty acids such as palmitic acid, stearic acid, behenic acid, montanic acid, and the like and alcohols such as stearyl alcohol, aralkyl alcohol, behenyl alcohol, carnaubyl alcohol, ceryl alcohol, melissyl alcohol, and the like; fatty acid amides such as linoleic acid amide, oleic acid amide, lauric acid amide, and the like; saturated fatty acid bisamides such as methylene bisstearic acid amide, ethylene biscapric acid amide, ethylene bislauric acid amide, hexamethylene bisstearic acid amide, and the like; unsaturated fatty acid amides such as ethylene bisoleic acid amide, hexamethylene bisoleic acid amide, N,N′-dioleyl adipic acid amide, N,N′-dioleyl sebacic acid amide, and the like; aromatic bisamides such as m-xylene bisstearic acid amide, N, N′-distearyl isophthalic acid amide, and the like; aliphatic metal salts (generally referred to as metal soaps) such as calcium stearate, calcium laurate, zinc stearate, magnesium stearate, and the like; waxes obtained by grafting on aliphatic hydrocarbon waxes by using vinyl monomers such as styrene, acrylic acid, and the like; partial esterification products of fatty acids and polyhydric alcohols, such as behenic acid monoglyceride; and methyl esterification products having a hydroxyl group that are obtained by hydrogenation of vegetable fats and oils.

Preferred among these release agents are hydrocarbon waxes such as paraffin wax or Fischer-Tropsch waxes, or fatty acid ester waxes such as carnauba wax, from the viewpoint of improving low-temperature fixability and hot offset resistance.

The content of the release agent that is used is preferably 3.0 mass % to 15.0 mass % relative to the toner particle. Hot offset resistance can readily be brought out efficiently when the content of the release agent lies in this range.

Charge Control Agent

The toner particle may contain a charge control agent. The charge control agent is not particularly limited, and known charge control agents can be used. In particular, a charge control agent that affords high charging speed and that allows stably maintaining a constant charge amount is preferable herein. The charge control agent may be added internally or externally to the toner particle.

The following are examples of charge control agents that control the toner particle to a negative chargeability: organometal compounds and chelate compounds such as monoazo metal compounds, acetylacetone-metal compounds, and metal compounds of aromatic oxycarboxylic acids, aromatic dicarboxylic acids, oxycarboxylic acids, and dicarboxylic acids. Also included in addition to the preceding are, e.g., aromatic oxycarboxylic acids, aromatic monocarboxylic acids, and aromatic polycarboxylic acids and their metal salts, anhydrides, and esters, and phenol derivatives such as bisphenol. Additional examples are urea derivatives, metal-containing salicylic acid compounds, metal-containing naphthoic acid compounds, boron compounds, quaternary ammonium salts, and calixarene.

On the other hand, charge control agents that control the toner particle to a positive chargeability can be exemplified by the following: nigrosine and nigrosine modifications by, e.g., fatty acid metal salts; guanidine compounds; imidazole compounds; quaternary ammonium salts such as tributylbenzylammonium 1-hydroxy-4-naphthosulfonate, and tetrabutylammonium tetrafluoroborate, and their onium salt analogues, such as phosphonium salts, and their lake pigments; triphenylmethane dyes and their lake pigments (the laking agent is exemplified by phosphotungstic acid, phosphomolybdic acid, phosphomolybdotungstic acid, tannic acid, lauric acid, gallic acid, ferricyanides, and ferrocyanides); metal salts of higher fatty acids; and resin-type charge control agents.

These charge control agents can be used singly or in combinations of two or more types. The content of the charge control agent in the toner particle is preferably 0.01 mass % to 10 mass %.

External Additive

The toner particle can be used as toner without external addition, but in order to further improve flowability, chargeability, cleaning performance and the like, a toner may be obtained through further external addition of a fluidizing agent, a cleaning aid and the like, which are so-called external additives. Examples of external additives include inorganic oxide fine particles such as silica fine particles, alumina fine particles and titanium oxide fine particles, and inorganic titanate compound fine particles such as strontium titanate and zinc titanate. The foregoing can be used singly or in combinations of two or more types.

The BET specific surface area of the external additive is preferably 10 m²/g to 450 m²/g. The BET specific surface area is determined by low-temperature gas adsorption method relying on a dynamic constant pressure method, in accordance with a multi-point BET method. Specifically, nitrogen gas is caused to be adsorbed onto the sample surface, using a specific surface area measuring device (product name: Gemini 2375 Ver. 5.0, by Shimadzu Corporation), and a measurement is then performed in accordance with the multi-point BET method, to thereby calculate a BET specific surface area (m²/g).

The total amount of these various external additives is preferably 0.05 parts by mass to 10 parts by mass, more preferably 0.1 parts by mass to 5 parts by mass, relative to 100 parts by mass of the toner particle.

Developer

The toner can be used as a magnetic or non-magnetic one-component developer, but may be used as a two-component developer by being mixed with a carrier. As the carrier, there can be used magnetic particles made up of known materials, for instance, metals such as iron, ferrite or magnetite, and alloys of these metals with metals such as aluminum or lead. Ferrite particles are preferably used among the foregoing. For instance, a coated carrier in which the surface of magnetic particles is coated with a coating agent such as a resin, or a resin dispersion-type carrier resulting from dispersing a magnetic fine powder in a binder resin or the like, may be used as the carrier. The volume-average particle diameter of the carrier is preferably 15 μm to 100 μm, more preferably 25 μm to 80 μm.

Toner Production Method

Any method may be used for producing the toner particle. For instance, a toner particle may be obtained through melt-kneading of a composition for a toner particle containing a compound containing a polyvalent element, the compound represented by Formula (1) and a binder resin, and, as needed, a colorant a release agent and the like, followed by pulverization. Also, a toner particle may be obtained by mixing, in an aqueous medium, the compound containing a polyvalent element, the compound represented by Formula (1) and monomers and/or polymers that form a binder resin, and, as needed, a colorant a release agent and the like, to form droplets or particles containing the foregoing, followed by polymerization or aggregation. Among these production methods, an example will be explained in detail below of a method for producing a toner particle by emulsification aggregation. The emulsification aggregation method is a producing method for a toner particle by preparing beforehand a dispersion of resin particles sufficiently smaller than the target particle diameter of the toner particle, and causing the resin fine particles to aggregate in an aqueous medium. One aspect of the toner production method (emulsification aggregation) of the present disclosure may include a step of preparing a resin particle dispersion by dispersing resin particles containing a binder resin and the compound represented by Formula (1), in an aqueous medium, and a step of forming aggregate particles through aggregation of the resin particles using a compound containing at least one polyvalent element selected from the group consisting of magnesium, calcium, aluminum, boron and iron. The method may include a step of fusing the aggregate particles through heating. The method may further include a cooling step, a washing step, a drying step and the like, after the fusion step.

Step of Preparing a Dispersion

For instance, the resin particle dispersion may be prepared as follows. In a case specifically where the resin in the resin particles is a homopolymer or copolymer (vinyl resin) of a vinylic monomer, the vinylic monomer is subjected to emulsion polymerization or seed polymerization in an ionic surfactant; as a result, a dispersion can be prepared that results from dispersing resin particles of the homopolymer or copolymer (vinyl resin) of the vinylic monomer in the ionic surfactant. In a case where the resin in the resin particles is other than a vinyl-based resin such as a polyester resin, a mixed solution is obtained by mixing the resin with an aqueous medium having an ionic surfactant or polymer electrolyte dissolved therein. The mixed solution is thereafter caused to dissolve by being heated to or above the melting point or softening point, whereupon a dispersion can be prepared through dispersion of the resin particles in an ionic surfactant, using a disperser or stirrer that delivers strong shearing forces, such as a homogenizer. The means of dispersion is not particularly limited, and examples thereof include known dispersion devices such as a rotary shear homogenizers, ball mills having a medium, sand mills and a dyno mills.

Further, phase inversion emulsification method may be resorted to as the method for preparing the dispersion. In a phase inversion emulsification method, resin particles are obtained by mixing a binder resin and the compound represented by Formula (1) with an organic solvent capable of dissolving the foregoing, dissolving the mixture by heating, adding as needed a neutralizing agent or a dispersion stabilizer, and stirring the whole, with dropwise addition of an aqueous solvent, to obtain emulsion particles, after which the organic solvent is removed from the resin dispersion. The order of addition of the neutralizing agent or the dispersion stabilizer may be reversed. The number-average particle diameter of the dispersed resin particles is ordinarily 1.00 μm or smaller, and is preferably from 0.01 μm to 1.00 μm.

A dispersion of the colorant is obtained by dispersing at least the colorant in a dispersing agent. The number-average particle diameter of the colorant particles is preferably 0.5 μm or smaller, more preferably 0.2 μm or smaller.

The release agent dispersion is obtained by dispersing at least the release agent in the dispersing agent. The number-average particle diameter of the release agent particles is preferably 2.0 μm or smaller, more preferably 1.0 μm or smaller.

The combination of binder resin, colorant, and release agent is not particularly limited, and may be freely selected in accordance with the intended purpose.

Besides the binder resin dispersion, the colorant dispersion, and the release agent dispersion, there may be further mixed in a particle dispersion resulting from dispersing appropriately selected particles, in a dispersing agent. The particles contained in the particle dispersion are not particularly limited and may be selected as appropriate depending on the intended purpose; examples thereof include internal additive particles, charge control agent particles, inorganic particles and abrasive particles. These particles may be dispersed in the binder resin dispersion or in the colorant dispersion.

Examples of the dispersion medium contained in the binder resin dispersion, the colorant dispersion, the release agent dispersion, the particle dispersion and the like include aqueous media containing a polar surfactant. Examples of aqueous media include water such as distilled water and ion-exchanged water, and alcohols. The foregoing may be used singly or in combination of two or more types. The content of the polar surfactant cannot be prescribed categorically, and can be appropriately selected depending on the intended purpose.

Examples of the polar surfactant include anionic surfactants such as sulfate ester salt-based, sulfonate salt-based, phosphate ester-based and soap-based surfactants, as well as cationic surfactants such as amine salt-type surfactants, and quaternary ammonium salt-type surfactants. Concrete examples of anionic surfactants include sodium dodecylbenzene sulfonate, sodium dodecyl sulfate, sodium alkylnaphthalene sulfonates and sodium dialkylsulfosuccinates. Concrete examples of cationic surfactants include alkylbenzenedimethylammonium chlorides, alkyltrimethylammonium chlorides and distearylammonium chloride. The foregoing may be used singly or in combination of two or more types. These polar surfactants and non-polar surfactants can also be used in combination. Examples of non-polar surfactants include polyethylene glycol-based, alkylphenol ethylene oxide adduct-based, and polyhydric alcohol-based non-polar surfactants.

The content of the colorant particles is preferably 0.1 parts by mass to 30 parts by mass relative to 100 parts by mass of the binder resin in the aggregated particle dispersion that is formed in the below-described aggregation step. The content of the release agent particles is about 0.5 parts by mass to 25 parts by mass, preferably 5 parts by mass to 20 parts by mass, relative to 100 parts by mass of the binder resin in the aggregated particle dispersion that is formed in the aggregation step.

In order to control the chargeability of the obtained toner more finely, charge control particles and binder resin particles may be added after formation of the aggregated particles. The particle diameter of the resin particles in the binder resin dispersion, the colorant particles in the colorant dispersion, the release agent particles in the release agent dispersion and the particles in the particle dispersion may be measured using a particle size distribution measuring device LA-920 of laser diffraction/scattering type, by Horiba Ltd.

Aggregation Step

The aggregation step of forming the aggregated particles is a step of forming aggregated particles including binder resin particles, colorant particles, release agent particles and the like, in an aqueous medium that contains binder resin particles, colorant particles, release agent particles and the like. The aggregated particles can be formed in the aqueous medium by adding for instance a flocculant, a pH adjusting agent and a stabilizer to the aqueous medium, with mixing, and by applying as appropriate temperature, mechanical power and the like. The above compound containing a polyvalent element may be used as the flocculant.

Examples of the pH adjusting agent include alkalis such as ammonia and sodium hydroxide, and acids such as nitric acid and citric acid. Examples of the flocculant include salts of monovalent metals such as sodium and potassium; salts of divalent metals such as calcium and magnesium; salts of trivalent metals such as iron and aluminum; as well as alcohols such as methanol, ethanol and propanol.

Examples of the stabilizer include mainly the polar surfactant itself, and aqueous media that contain the polar surfactant. For instance, a cationic stabilizer can be selected in a case where the polar surfactant contained in the respective particle dispersion is anionic.

Preferably, addition and mixing of the flocculant and so forth are performed at a temperature equal to or lower than the glass transition temperature of the resin contained in the aqueous medium. Aggregation proceeds in a stable state when mixing is performed under such a temperature condition. Mixing can be performed using for instance a known mixing device such as a homogenizer or a mixer. In the aggregation step, aggregated particles having a core/shell structure in which a shell layer is formed on the surface of core aggregated particles may be obtained by forming a coat layer (shell layer) on the surface of the aggregated particles through adhesion of second binder resin particles thereonto, using a binder resin particle dispersion containing the second binder resin particles. The second binder resin particles used at this time may be identical to or different from the binder resin particles that make up the core aggregated particles. The aggregation step may be repeatedly carried out, divisionally in a plurality of stages.

Fusion Step

The fusion step is a step of fusing through heating, the obtained aggregated particles. Prior to the fusion step, a pH adjusting agent, a polar surfactant, a non-polar surfactant and the like can be added as appropriate in order to prevent melt-adhesion of toner particles to one another. The heating temperature may range from the glass transition temperature of the resin contained in the aggregated particles (the glass transition temperature of the resin having the highest glass transition temperature, in a case where there are two or more types of resin) up to the decomposition temperature of the resin. The heating temperature varies therefore depending on the type of resin of the binder resin particles, and cannot be defined categorically, but ordinarily lies in a range from the glass transition temperature of the resin contained in the aggregated particles up to 140° C. Heating can be accomplished using a known heating device/instrument.

A short time suffices as the fusion time provided that the heating temperature is high; a long fusion time is however required if the heating temperature is low. The duration of fusion depends thus on the heating temperature and hence cannot be defined categorically, but ranges ordinarily from 30 minutes to 10 hours.

The toner particle obtained as a result of the above steps can be recovered by solid-liquid separation in accordance with a known method, and may be then washed, dried and the like under appropriate conditions.

External Addition Step

The obtained toner particle, as-is, can be used as toner; however, from the viewpoint of adjusting the chargeability, flowability, storability of the toner and the like, an external additive may be added, as needed, to obtain a toner. The stirring equipment in which the external addition treatment is carried out is not particularly limited so long as it is capable of causing the external additive to adhere to the surface of the toner particle. For instance, the external addition treatment may be performed using equipment that allows for mixing and stirring, such as a double-cone mixer, a V-type mixer, a drum-type mixer, a super mixer, a Henschel mixer, a Nauta mixer, Mechano Hybrid (by Nippon Coke & Engineering Co., Ltd.) or Nobilta (by Hosokawa Micron Corporation).

Methods for measuring various physical properties of toner, the toner particle and raw materials will be explained below.

Identification and Quantification of the Binder Resin

Pyrolysis gas chromatography-mass spectrometry (hereafter also referred to as “Pyrolysis GC/MS”) and NMR are resorted to herein in order to identify the constituent composition and ratios in the binder resin. The type of constituent compounds is identified by analyzing the mass spectrum of components of the decomposition product of the resin, which is generated when the resin is thermally decomposed at 550° C. to 700° C. The specific measurement conditions are as follows.

Pyrolysis GC/MS Measurement Conditions

Pyrolysis device: JPS-700 (Nippon Analytical Industry Co., Inc.)
Decomposition temperature: 590° C.
GC/MS device: Focus GC/ISQ (Thermo Fisher Scientific Corp.)
Column: RP-5MS, length 60 m, inner diameter 0.25 mm, film thickness 0.25 μm
Injection port temperature: 200° C.
Flow pressure: 100 kPa
Split: 50 mL/min
MS ionization: EI
Ion source temperature: 200° C., Mass Range 45-650

Next, the abundance ratio of the constituent compounds of the identified resin is measured and calculated by ¹H-NMR. The structure is elucidated using an FT NMR apparatus JNM-EX400 (by JEOL Ltd.) [′H-NMR, 400 MHz, CDCl₃, room temperature (25° C.)].

¹H-NMR Measurement Conditions

Measurement frequency: 400 MHz

Pulse conditions: 5.0 μs

Frequency range: 10500 Hz

Number of scans: 1024 scans

Measurement temperature: 25° C.

Sample: a sample is prepared by placing 50 mg of a measurement sample in a sample tube having an inner diameter of 5 mm, with addition of deuterated chloroform (CDCl₃) as a solvent, followed by dissolution in a thermostatic bath at 40° C.

The mol ratio of each monomer component is obtained from the integrated value of the obtained spectrum, and the composition ratio (% by mass) is calculated based thereon.

Method for Measuring the Weight-Average Molecular Weight (Mw) of the Binder Resin

The weight-average molecular weight (Mw) of the binder resin is measured by gel permeation chromatography (GPC), as follows. Firstly, the binder resin is dissolved in tetrahydrofuran (THF) over 24 hours at room temperature. The obtained solution is then filtered through a solvent-resistant membrane filter “MYSYORI DISC” (by Tosoh Corporation) having a pore diameter of 0.2 to obtain a sample solution. The sample solution is adjusted so that the concentration of the component soluble in THF is about 0.8 mass %. This sample solution is then used for measurements under the following conditions.

Device: HLC8120 GPC (detector: RI) (by Tosoh Corporation)

Column: seven columns Shodex KF-801, 802, 803, 804, 805, 806, 807 (by Showa Denko KK)

Eluent: tetrahydrofuran (THF)

Flow rate: 1.0 ml/min

Oven temperature: 40.0° C.

Sample injection amount: 0.10 ml

To calculate the molecular weight of the sample, there is used a molecular weight calibration curve created using a standard polystyrene resin (product name “TSK STANDARD POLYSTYRENE F-850, F-450, F-288, F-128, F-80, F-40, F-20, F-10, F-4, F-2, F-1, A-5000, A-2500, A-1000 or A-500”, by Tosoh Corporation).

Method for Measuring the Weight-Average Particle Diameter (D4) and the Number-Average Particle Diameter (D1) of the Toner Particle

The weight-average particle diameter (D4) of the toner particles is calculated by measuring at the number of effective measurement channels of 25,000 by using a precision particle size distribution measuring device “Coulter Counter Multisizer 3” (registered trademark, manufactured by Beckman-Coulter Inc.) equipped with a 100 μm aperture tube and based on a fine pore electrical resistance method and dedicated software “Beckman Coulter Multisizer 3 Version 3.51” (produced by Beckman-Coulter Inc.) for setting measurement conditions and analyzing measurement data, and performing analysis of measurement data.

An aqueous electrolyte aqueous solution used in the measurements can be prepared through dissolution of special-grade sodium chloride to a concentration of about 1 mass % in ion-exchanged water; for instance, “ISOTON II” (by Beckman Coulter, Inc.) can be used herein as the electrolyte aqueous solution. Before performing the measurement and analysis, the dedicated software is set as follows.

On a “CHANGE STANDARD MEASUREMENT METHOD (SOM) SCREEN” of the dedicated software, the total count number in the control mode is set to 50,000 particles, the number of measurement cycles to 1, and a Kd value is set to a value obtained using “STANDARD PARTICLES 10.0 μm” (manufactured by Beckman-Coulter Inc.). By pressing a threshold/noise level measurement button, the threshold and noise level are automatically set. Further, the current is set to 1600 μA, the gain to 2, and the electrolyte aqueous solution to ISOTON II, and the flush of the aperture tube after measurement is checked. On the “PULSE TO PARTICLE DIAMETER CONVERSION SETTING SCREEN” of the dedicated software, a bin spacing is set to a logarithmic particle diameter, a particle diameter bin to 256 particle diameter bin, and the particle diameter range from 2 μm to 60 μm. The specific measurement method is as follows.

(1) About 200 mL of the electrolyte aqueous solution is put in a 250 mL glass round-bottom beaker provided with the Multisizer 3, the beaker is set on a sample stand, and counterclockwise stirring with a stirrer rod is performed at 24 revolutions/sec. Then, dirt and air bubbles in the aperture tube are removed by the “FLUSH OF THE APERTURE TUBE” function of the dedicated software.

(2) About 30 mL of the electrolyte aqueous solution is placed in a 100 mL flat-bottomed glass beaker, and about 0.3 mL of the following diluted solution is added as a dispersing agent thereto.
Diluted solution: prepared by threefold mass dilution of “Contaminon N” (10% by mass aqueous solution of a neutral detergent for cleaning precision measuring instruments that is composed of a nonionic surfactant, an anionic surfactant, and an organic builder and has pH 7, manufactured by Wako Pure Chemical Industries, Ltd.) with ion-exchanged water.

(3) a predetermined amount of ion-exchanged water is charged into the water tank of an ultrasonic disperser “Ultrasonic Dispersion System Tetora 150” having an electrical output of 120 W (by Nikkaki Bios Co., Ltd.), and internally equipped with two oscillators that oscillate at a frequency of 50 kHz and are disposed at a phase offset by 180 degrees, and then about 2 mL of the above diluted solution are added into the water tank.

(4) The beaker of (2) hereinabove is set into a fixing hole of the ultrasonic disperser, and the ultrasonic disperser is operated. The height position of the beaker is adjusted so that the resonance state of the liquid level of the electrolytic solution in the beaker is maximized.

(5) With the electrolytic aqueous solution in the beaker of (4) hereinabove irradiated with ultrasonic waves, about 10 mg of toner (particle) is added little by little to the electrolytic aqueous solution and dispersed. Then, the ultrasonic dispersion processing is further continued for 60 sec. In the ultrasonic dispersion, the water temperature in the water tank is adjusted, as appropriate, to be from 15° C. to 40° C.

(6) The electrolytic aqueous solution of (5) hereinabove in which the toner (particle) was dispersed is added dropwise by using a pipette to the round-bottomed beaker of (1) that was installed in the sample stand, and the measurement concentration is adjusted to about 5%. Then, the measurement is performed until the number of measured particles reaches 50,000.

(7) The measurement data are analyzed with the dedicated software provided with the device, and the weight average particle diameter (D4) is calculated. The “Arithmetic diameter” in the “Analysis/Volume Statistics (arithmetic average)” screen, with Graph/volume % set in the dedicated software, is the weight-average particle diameter (D4), while the “Arithmetic average diameter” in the “Analysis/Number Statistics (arithmetic average)” screen, with Graph/number % set in the dedicated software, is the number-average particle diameter (D1).

Methods for Identifying the Compound Represented by Formula (1) in the Toner and Measuring the Content of the Compound Represented by Formula (1) in the Toner

Preparation of an Extracted Sample

Herein 2 g of toner and 18 g of ethanol are added to a sample tube, and the whole is homogenized through manual shaking of the sample tube, after which the sample tube is irradiated with ultrasounds for 5 min. Thereafter, the sample tube is allowed to stand in a thermostatic bath at 60° C. a whole day and night, and is further allowed to stand at room temperature for 3 days. The supernatant of the sample after standing is collected, and filtered using a syringe filter (pore size 250 nm) made of PTFE, and the resulting filtrate is used as an extraction sample.

GC/MS Analysis

The GC/MS device that is utilized herein is GC TRACE-1310 (by Thermo Fisher Scientific Inc.), the detector that is utilized herein is a single quadrupole analyzer MS ISQ LT (by Thermo Fisher Scientific Inc.), and the autosampler that is utilized herein is TRIPLUS RSH (by Thermo Fisher Scientific Inc.). The measurement is performed under the conditions set out below.

Sample amount: 1 μL (liquid introduction)

Column: HP5-MS (by Agilent Technologies Inc.)

Length: 30 m, inner diameter of 0.25 mm, film thickness of 0.25 μm

Split ratio: 10

Split flow: 15 mL/min

MS ionization: EI

Column temperature conditions: holding at 40° C. for 3 min, followed by raising to 300° C. at 10° C./min, and holding for 10 min.

Ion source temperature: 250° C.

Mass Range: m/z 45-1000

Transport line temperature: 250° C.

Creation of a Calibration Curve

Samples for creating a calibration curve are prepared so that the concentration of the compound represented by Formula (1) in an ethanol solution is 10 ppm, 50 ppm, 100 ppm and 250 ppm, respectively. The samples are measured under the above conditions, and a calibration curve is created from the surface area values of a peak derived from the compound represented by Formula (1).

The structure of the compound represented by Formula (1) can be determined through analysis of the sample using an FT NMR device JNM-EX400 (by JEOL Ltd.) [¹H-NMR, 400 MHz, CDCl₃, room temperature (25° C.)] (¹³C-NMR and others are also used concomitantly). The compound represented by Formula (1) is identified and the content thereof measured on the basis of the information obtained in accordance with the above method.

Method for Measuring the Content of the Polyvalent Element in the Toner

The content of the polyvalent element of the toner is measured by X-ray fluorescence, and is worked out using a calibration curve. The X-ray fluorescence measurement of the polyvalent element conforms to JIS K 0119-1969, specifically as follows.

The measurement device that is utilized herein is a wavelength-dispersive X-ray fluorescence analyzer “Axios” (by PANalytical B. V.), with dedicated software “SuperQ ver. 4.0F” (by PANalytical B. V.) for setting measurement conditions and analyzing measurement data. Rhodium (Rh) is used as the anode of the X-ray tube bulb, the measurement atmosphere is vacuum, and the measurement diameter (collimator mask diameter) is set to 27 mm. Detection is carried out using a proportional counter (PC) to measure light elements, and using a scintillation counter (SC) to measure heavy elements.

Creation of a Boron Calibration Curve

To obtain pellets for creating a calibration curve for working out the content of the polyvalent element in the toner, borax (Na₂[B₄O₅(OH)₄]·8H₂O) is added, to a content of 0.10 parts by mass relative to 100 parts by mass of binder (Spectro Blend, components: C 81.0, O 2.9, H 13.5 and N 2.6 (mass %), chemical formula: C₁₉H₃₈O N, form: powder (44 μm), by Rigaku Corporation)), and the whole is thoroughly mixed using a coffee mill, whereupon 4 g of the resulting mixture are placed in a dedicated aluminum ring for pressing, and are smoothed, followed by pressing for 60 seconds at 20 MPa using a tablet compression molder “BRE-32” (by Maekawa Testing Machine Mfg. Co. Ltd.), to prepare pellets molded to a thickness of 2 mm and a diameter of 39 mm. Respective pellets are similarly produced by mixing and pellet-molding so that borax is 0.50 parts by mass, 1.00 parts by mass, 5.00 parts by mass and 10.00 parts by mass, and there is measured each count rate (units: cps) of the B-Kα ray observed at a diffraction angle (2θ) of 41.75°, using PET as an analyzer crystal. In this case, the acceleration voltage and current value of the X-ray generator are set to 32 kV and 125 mA, respectively, and the measurement time is set to 10 seconds.

A calibration curve of a linear function is obtained, with the obtained X-ray count rate as the vertical axis and the boron addition concentration, calculated from the addition amount of borax in each calibration curve sample, as the horizontal axis.

Quantification of Boron in the Toner

In order to quantify the boron content in the toner, 4 g of the toner are placed in a dedicated aluminum ring for pressing, and pellet molding is performed in the same way as in the samples for creating a calibration curve. The molded toner pellets are measured under the same conditions as in the case of the calibration curve samples, and the content of boron (mass ppm) in the toner is worked out on the basis of created calibration curve. The number of moles of boron is also calculated from the content of boron (mass ppm) in the toner.

Creation of an Aluminum Calibration Curve and Quantification of Aluminum in Toner

Calibration curve samples are created by modifying borax to aluminum hydroxide (Al(OH)₃), and there is measured the count rate (units: cps) of the Al-Kα ray observed at a diffraction angle (2θ) of 144.8°, using PET as the analyzer crystal, and with the acceleration voltage and current value of the X-ray generator set to 32 kV and 125 mA, and the measurement time to 10 seconds; a calibration curve is then obtained in the form of a first-order correlation with the addition concentration of aluminum.

To quantify the content of aluminum in the toner, a toner sample is prepared in the same way as in the quantification of boron, a measurement is performed under conditions similar to those of the calibration curve samples, and the content of aluminum (mass ppm) in the toner is worked out on the basis of the aluminum calibration curve. The number of moles of aluminum is calculated from the content of aluminum (mass ppm) in the toner.

Creation of a Magnesium Calibration Curve and Quantification of Magnesium in Toner

Calibration curve samples are created by modifying borax to magnesium hydroxide (Mg(OH)₂), and there is measured the count rate (units: cps) of the Mg-Kα ray observed at a diffraction angle (2θ) of 22.93°, using PET as the analyzer crystal, and with the acceleration voltage and current value of the X-ray generator set to 32 kV and 125 mA, and the measurement time to 50 seconds; a calibration curve is then obtained in the form of a first-order correlation with the addition concentration of magnesium.

To quantify the content of magnesium in the toner, a toner sample is prepared in the same way as in the quantification of boron, a measurement is performed under conditions similar to those of the calibration curve samples, and the content of magnesium (mass ppm) in the toner is worked out on the basis of the magnesium calibration curve. The number of moles of magnesium is calculated from the content of magnesium (mass ppm) in the toner.

Creation of a Calcium Calibration Curve and Quantification of Calcium in Toner

Calibration curve samples are created by modifying borax to calcium hydroxide (Ca(OH)₂), and there is measured the count rate (units: cps) of the Ca-Kα ray observed at a diffraction angle (2θ) of 113.0°, using PET as the analyzer crystal, and with the acceleration voltage and current value of the X-ray generator set to 32 kV and 125 mA, and the measurement time to 10 seconds; a calibration curve is then obtained in the form of a first-order correlation with the addition concentration of calcium.

To quantify the content of calcium in the toner, a toner sample is prepared in the same way as in the quantification of boron, a measurement is performed under conditions similar to those of the calibration curve samples, and the content (mass ppm) in the toner is worked out on the basis of the calcium calibration curve. The number of moles of calcium is calculated from the content of calcium (mass ppm) in the toner.

Creation of an Iron Calibration Curve and Quantification of Iron in Toner

Calibration curve samples are created by modifying borax to iron oxide (Fe₂O₃), and there is measured the count rate (units: cps) of the Fe-Kα ray observed at a diffraction angle (2θ) of 57.48°, using PET as the analyzer crystal, and with the acceleration voltage and current value of the X-ray generator set to 60 kV and 66 mA, and the measurement time to 10 seconds; a calibration curve is then obtained in the form of a first-order correlation with the addition concentration of iron.

To quantify the content of iron in the toner, a toner sample is prepared in the same way as in the quantification of boron, a measurement is performed under conditions similar to those of the calibration curve samples, and the content of iron (mass ppm) in the toner is worked out on the basis of the iron calibration curve. The number of moles of iron is calculated from the content of iron (mass ppm) in the toner.

Ratio (A/B) of the Number of Moles A of the Compound Represented by Formula (1) and the Number of Moles B of the Polyvalent Element

The ratio (A/B) of the number of moles A of the compound represented by Formula (1) and the number of moles of the polyvalent element is calculated by calculating the number of moles A of the compound represented by Formula (1) on the basis of the content of the identified compound represented by Formula (1) in the toner and calculating the number of moles B of the polyvalent element on the basis of the content of the identified polyvalent element in the toner.

Separation of the Binder Resin from the Toner

The binder resin in the toner particle is retrieved, for instance, through separation, by solvent gradient elution, of an extract utilizing tetrahydrofuran (THF). The preparation method is as follows.

Herein 10.0 g of toner particle are weighed, laid on a tubular filter paper (No. 84, by Toyo Roshi Kaisha Ltd.), and are set in a Soxhlet extractor. Extraction is performed for 20 hours using 200 mL of THF as the solvent; the solid fraction obtained upon removal of solvent from the extract is a THF-soluble fraction. The THF-soluble fraction includes the binder resin. The above is performed multiple times, to yield the required amount of THF-soluble fraction.

Gradient preparative HPLC (LC-20AP high-pressure gradient preparative system, by Shimadzu Corporation; SunFire preparative column 50 mm φ250 mm, by Waters Corporation) is used in the solvent gradient elution method. The column temperature is 30° C., the flow rate is 50 mL/min, acetonitrile is used as the poor solvent and THF is used as the good solvent, in the mobile phase. A sample obtained by dissolving, in 1.5 mL of THF, 0.02 g of the THF-soluble fraction obtained through extraction is used herein as a sample for separation. The mobile phase starts from a composition of 100% acetonitrile, and 5 minutes after sample injection, the ratio of THF is increased by 4% per minute, such that the composition of the mobile phase reaches 100% of THF in the course of 25 minutes. Components can be separated through drying of the obtained fractions, and a binder resin can be obtained as a result. Which fraction component is the binder resin can be discriminated in accordance with a below-described ¹³C-NMR (solid state) measurement. A required amount of binder resin is obtained by repeating solvent gradient elution, as needed. The ratio of the mass of the obtained binder resin and the mass of the toner particle used in retrieving the binder resin is taken herein as the content (mass %) of the binder resin in the toner particle.

Confirmation of the Structure of the Binder Resin Separated from the Toner, and Measurement of the Content of the Structure Represented by Formula (2) in the Binder Resin in the Toner Particle

The content of the structural unit represented by Formula (2) in the binder resin can be ascertained in accordance with a known analytical method such as ¹³C-NMR (solid state) measurement.

Measurement conditions of ¹³C-NMR (solid state)

Device: JNM-ECX500II by JEOL RESONANCE Co., Ltd.

Sample tube: 3.2 mmφ

Sample amount: 150 mg

Measurement temperature: room temperature

Pulse mode: CP/MAS

Measured nucleus frequency: 123.25 MHz (¹³C)

Reference substance: adamantane (external standard: 29.5 ppm)

Sample rotational speed: 20 kHz

Contact time: 2 ms

Delay time: 2 s

Number of scans: 1024 scans

The peaks obtained in the above measurements are separated by the type of monomer unit in the binder resin, and are each identified. The structure of the monomer represented by Formula (2) is identified, and the content thereof is calculated on the basis of the integral ratio of the peaks.

### EXAMPLES

The present disclosure will be specifically described hereafter by means of examples, but the present disclosure is not limited to these examples. Unless otherwise specified, the term “parts” concerning the materials in the examples and comparative examples refers to parts by mass in all instances.

Production of Polyester Resin 1

The components below were added to a reaction vessel equipped with a stirrer, a thermometer, a nitrogen introduction tube, a dewatering tube and a pressure-reducing device, with heating up to a temperature of 130° C. while under stirring.

Terephthalic acid: 100.0 parts

Trimellitic acid anhydride: 3.3 parts

Ethylene glycol: 17.1 parts

Isosorbide: 48.4 parts

Ethylene oxide 5-mole-adduct of bisphenol A: 7.0 parts

Then 0.3% of titanium (IV) isopropoxide as an esterification catalyst were added relative to the total amount of monomer components having been added to the reaction vessel, the temperature was raised to 235° C. for 1 hour, under a nitrogen gas stream, and the reaction was conducted for 3 hours. The reaction was thereafter conducted to a desired molecular weight, while reducing the pressure in the interior of the reaction vessel down to 10.0 mmHg, to yield Polyester resin 1. Once the required molecular weight was reached, the reaction was terminated to obtain Polyester resin 1. The weight-average molecular weight (Mw) of Polyester resin 1 was 50000. The proportion of the structural unit represented by Formula (2) in Polyester resin 1 was 4.0 mass %.

Production of Polyester Resin 2
Fumaric acid: 100.0 parts
Trimellitic acid anhydride: 4.4 parts
Ethylene oxide 5-mole-adduct of bisphenol A: 37.9 parts
Propylene oxide 5-mole-adduct of bisphenol A: 36.3 parts

Polyester resin 2 was obtained in the same manner as Polyester resin 1 except that herein the monomer components added to the reactor were the above components. The weight-average molecular weight (Mw) of the obtained Polyester resin 2 was 44000. The proportion of the structural unit represented by Formula (2) in Polyester resin 2 was 45.6 mass %.

Production of Styrene Acrylic Resin Dispersion 1
Styrene: 78 parts
n-butyl acrylate: 22 parts
Anionic surfactant (sodium dodecylbenzene sulfonate): 3 parts
Ethylene glycol monododecyl ether: 0.0021 parts
Ion-exchanged water: 80 parts

The above components were charged into a vessel, and a monomer emulsion A was produced using a homogenizer.
Ion-exchanged water: 200 parts
Anionic surfactant (sodium dodecylbenzene sulfonate): 0.5 parts

The above components were charged into a polymerization reaction vessel, a reflux tube was fitted, the whole was stirred slowly while under injection of nitrogen, and the polymerization flask was heated up to, and held at, 75° C. in a water bath.

Then 10 parts of the monomer emulsion A were added dropwise to the polymerization reaction vessel over 10 minutes, using a metering pump. Next, 1.05 parts of ammonium persulfate were dissolved in 20 parts of ion-exchanged water, and the resulting solution was added dropwise to the polymerization flask over 10 minutes, using a metering pump. Stirring was continued in this state for 1 hour. The remaining monomer emulsion A was added dropwise over 2 hours, using a metering pump. Once all additions were over, stirring was continued for a further 3 hours, and then ion-exchanged water was added, to adjust the solids concentration to 25.0%, and obtain Styrene acrylic resin dispersion 1.

Production of Styrene acrylic resin dispersion 2
Styrene: 126 parts
n-butyl acrylate: 14 parts
Anionic surfactant (sodium dodecylbenzene sulfonate): 4 parts
Ion-exchanged water: 59.2 parts

The above components were charged into a vessel, and a monomer emulsion B was produced using a homogenizer.
Ion-exchanged water: 133 parts
Anionic surfactant (sodium dodecylbenzene sulfonate): 0.6 parts

The above components were charged into a polymerization reaction vessel, a reflux tube was fitted, the whole was stirred slowly while under injection of nitrogen, and the polymerization flask was heated up to, and held at, 75° C. in a water bath. Then 10 parts of the monomer emulsion B were added dropwise to the polymerization reaction vessel over 10 minutes, using a metering pump. Next, 1.05 parts of ammonium persulfate were dissolved in 10 parts of ion-exchanged water, and the resulting solution was added dropwise to the polymerization flask over 10 minutes, using a metering pump. Stirring was continued in this state for 1 hour. The remaining monomer emulsion B was added dropwise over 2 hours, using a metering pump. Once all additions were over, stirring was continued for a further 3 hours, and then ion-exchanged water was added, to adjust the solids concentration to 40.0%, and obtain Styrene acrylic resin dispersion 2.

Preparation of Polyester Resin Dispersion 1
Polyester resin 1: 100 parts
Methyl ethyl ketone: 60 parts
Isopropyl alcohol: 10 parts
Ethylene glycol monododecyl ether: 0.0021 parts

The above components were charged into a reaction vessel equipped with stirrer, and the components were dissolved at 60° C. Once dissolution was confirmed, the reaction vessel was cooled down to 35° C., followed by addition of 3.5 parts of a 10% aqueous ammonia solution. Next, 300 parts of ion-exchanged water were added dropwise into the reaction vessel over 3 hours, to prepare a polyester resin dispersion. Methyl ethyl ketone and isopropyl alcohol were subsequently removed using an evaporator. Thereafter, ion-exchanged water was added to adjust the solids concentration to 25.0%, and yield Polyester resin dispersion 1.

Preparation of Polyester Resin Dispersions 2 to 18

Polyester resin dispersions 2 to 18 were obtained in the same way as in the preparation of Polyester resin dispersion 1 except that it was modified that the type and addition amount of the polyester resin and of the compound represented by Formula (1) that were used, as given in Table 1.

TABLE 1

| Polyester | Polyester resin | | Compound represented by Formula (1) | | |
|---|---|---|---|---|---|
| resin | | Parts | | | Parts |
| dispersion | Resin | by mass | R¹ | n | by mass |
| 1 | Polyester resin 1 | 100 | Dodecyl group | 1 | 0.0021 |
| 2 | Polyester resin 1 | 100 | Dodecyl group | 1 | 0.0140 |
| 3 | Polyester resin 1 | 100 | Dodecyl group | 1 | 0.0280 |
| 4 | Polyester resin 1 | 100 | Dodecyl group | 1 | 0.0007 |
| 5 | Polyester resin 1 | 100 | Dodecyl group | 1 | 0.0004 |
| 6 | Polyester resin 1 | 100 | Dodecyl group | 1 | 0.0694 |
| 7 | Polyester resin 1 | 100 | Dodecyl group | 1 | 0.0867 |
| 8 | Polyester resin 1 | 100 | n-octyl group | 1 | 0.0028 |
| 9 | Polyester resin 1 | 100 | Ethylhexyl group | 1 | 0.0028 |
| 10 | Polyester resin 1 | 100 | Decyl group | 1 | 0.0028 |
| 11 | Polyester resin 1 | 100 | Tetradecyl group | 1 | 0.0028 |
| 12 | Polyester resin 1 | 100 | Docosyl group | 1 | 0.0028 |
| 13 | Polyester resin 1 | 100 | Docosyl group | 3 | 0.0028 |
| 14 | Polyester resin 2 | 100 | Dodecyl group | 1 | 0.0021 |
| 15 | Polyester resin 1 | 100 | — | — | — |
| 16 | Polyester resin 1 | 100 | n-butyl group | 1 | 0.0021 |
| 17 | Polyester resin 1 | 100 | Dodecyl group | 4 | 0.0021 |
| 18 | Polyester resin 1 | 100 | Octacosyl group | 1 | 0.0021 |

In the table, R¹ and n of the compound represented by Formula (1) respectively denote R¹ and n of the compound represented by Formula (1).

Preparation of a Release Agent Dispersion
Hydrocarbon wax (by Nippon Seiro Co., Ltd., product name: FNP0090, melting temperature Tw=90.2° C.): 270 parts
Anionic surfactant (sodium dodecylbenzene sulfonate): 10.5 parts
Ion-exchanged water: 700 parts

The above components were mixed and the release agent was dissolved at an internal liquid temperature of 120° C. in a pressure-ejection homogenizer (Gaulin homogenizer, by Manton-Gaulin Manuf. Co., Inc.), after which a dispersion treatment was performed at a dispersion pressure of 5 MPa for 120 minutes, and then at 40 MPa for 360 minutes, followed by cooling, to yield a release agent dispersion. As a result of a measurement of the particle size distribution of the release agent dispersion using a granularity measuring device (LA-950, by Horiba Ltd.), the volume-average particle diameter of the release agent particles contained in the dispersion was 220 nm. Ion-exchanged water was added thereafter, to adjust the solids concentration to 20.0%.

Preparation of colorant Dispersion 1
C. I. Pigment Red 122: 200 parts
Anionic surfactant (sodium dodecylbenzene sulfonate): 13 parts
Ion-exchanged water: 750 parts

Herein, 280 parts of ion-exchanged water and 13 parts of an anionic surfactant (sodium dodecylbenzene sulfonate) were charged into a stainless steel vessel where the liquid level stood at ⅓ of the height of the vessel once all the above components were added; after sufficient dissolution of the surfactant, 200 parts of C.I. Pigment Red 122 were then added and the whole was stirred, using a stirring machine, until there was no unwetted pigment left. Thereafter, 470 parts of ion-exchanged water were added, and the whole was further stirred to elicit sufficient defoaming. After defoaming, the whole was dispersed at 5,000 rpm for 10 minutes using a homogenizer (Ultra-Turrax T50, by IKA), and was defoamed through stirring for one day and night using a stirrer. After defoaming, the whole was dispersed again at 6,000 rpm for 10 minutes using a homogenizer, and was then further defoamed by being stirred for one day and night using a stirrer. Thereafter, the whole was dispersed at a pressure of 240 MPa using a high-pressure impact-type disperser Ultimizer (product name: HJP30006, by Sugino Machine Limited). Dispersion was performed so as to correspond to 25 passes, as converted from the total charge amount and the processing capacity of the disperser. The obtained dispersion was allowed to stand for 72 hours, to remove the precipitate, and ion-exchanged water was then added to adjust the solids concentration to 15%, and yield Colorant dispersion 1. The volume-average particle diameter of the particles in this colorant dispersion was 110 nm.

Preparation of Colorant Dispersion 2

Colorant dispersion 2 was obtained in the same way as in the preparation of Colorant dispersion 1, except that the colorant that was used was modified to C.I. Pigment Blue 15:3. The volume-average particle diameter of the particles in this colorant dispersion was 90 nm.

Preparation of Colorant Dispersion 3

Colorant dispersion 3 was obtained in the same way as in the preparation of Colorant dispersion 1, except that the colorant that was used was modified to C.I. Pigment Yellow 180. The volume-average particle diameter of the particles in this colorant dispersion was 120 nm.

Preparation of Colorant Dispersion 4

Colorant dispersion 4 was obtained in the same way as in the preparation of Colorant dispersion 1, except that the colorant that was used was modified to carbon black. The volume-average particle diameter of the particles in this colorant dispersion was 50 nm.

Production of Toner 1

Production of Toner Particle 1

| | | |
|---|---|---|
| Polyester resin dispersion 1 | 450 | parts |
| Styrene acrylic resin dispersion 2 | 50 | parts |
| Colorant dispersion 1 | 65 | parts |
| Release agent dispersion | 70 | parts |

Herein Polyester resin dispersion 1, Styrene acrylic resin dispersion 2 and the release agent dispersion were charged into a reactor (flask having a volume of 1 liter, with baffles and an anchor blade), and were mixed uniformly. Meanwhile, Colorant dispersion 1 was uniformly mixed in a 500 mL beaker, and was gradually added to the reactor while under stirring, to yield a mixed dispersion. Then 8.0 parts of a 5 mass % borax aqueous solution were added dropwise, while under stirring of the obtained mixed dispersion, to form aggregated particles.

Once dropwise addition was over, the interior of the system was purged with nitrogen, and the whole was held at 50° C. for 1 hour, and was further held at 55° C. for 1 hour. Thereafter the temperature was raised to and held at 90° C. for 30 minutes. Next, the temperature was lowered to 63° C. and was then held there for 3 hours, to form fusion particles. After a predetermined lapse of time, the obtained particles were cooled down to 40° C. at a ramp down rate of 0.5° C. per minute, and were then filtered, washed with water and dried, to yield Toner particle 1 having a weight-average particle diameter (D4) of 6.5 μm.

Production of Toner 1

Then 1.5 parts of hydrophobic silica (RY50, by Nippon Aerosil Co., Ltd.) were added to 100 parts of Toner particle 1 obtained above, and the whole was mixed using Mitsui Henschel Mixer (by Mitsui Miike Chemical Engineering Machinery Co., Ltd.). Thereafter, Toner 1 was obtained through sifting using a vibrating sieve having a mesh opening of 45 μm. Table 2 sets out physical properties and so forth of the obtained Toner 1.

Production of Toners 2 to 29

Toners 2 to 29 were obtained in accordance with the same production method as that of Toner 1, except that it was modified that herein the types or addition amounts of the polyester resin dispersion, the styrene acrylic resin dispersion, the colorant dispersion, and the flocculant as given in Table 2.

TABLE 2

| | | | | | | | Re- | | | | | | | | |
|---|---|---|---|---|---|---|---|---|---|---|---|---|---|---|---|
| | | | | | | | lease | | | | | | | | |
| | | | | | | | agent | | | | | | | | |
| | | | | | Colorant | | disper- | | | | | | | | |
| | Binder resin dispersion | | | | dispersion | | sion | Flocculant | | Element | | | | | |
| | | Num- | | Num- | | Num- | Num- | | Num- | contained | | | | | |
| | | ber | | ber | | ber | ber | | ber | Poly- | | Formula (1) | | | |
| | | of | | of | | of | of | | of | valent | | R¹-[OCH₂CH₂]ₙ—OH | | | Ratio |
| Toner | Type | parts | Type | parts | | parts | parts | Type | parts | element | ppm | R¹ | n | ppm | (A/B) |
| 1 | Polyester | 450 | Styrene | 50 | Colorant | 65 | 70 | 5 wt % borax | 8.0 | Boron | 280 | Dodecyl | 1 | 15 | 0.0025 |
| | resin | | acrylic resin | | dispersion | | | aqueous | | | | group | | | |
| | dispersion 1 | | dispersion 2 | | 1 | | | solution | | | | | | | |
| 2 | Polyester | 450 | Styrene | 50 | Colorant | 65 | 70 | 5 wt % borax | 3.0 | Boron | 106 | Dodecyl | 1 | 16 | 0.0071 |
| | resin | | acrylic resin | | dispersion | | | aqueous | | | | group | | | |
| | dispersion 1 | | dispersion 2 | | 1 | | | solution | | | | | | | |
| 3 | Polyester | 450 | Styrene | 50 | Colorant | 65 | 70 | 5 wt % borax | 8.0 | Boron | 276 | Dodecyl | 1 | 98 | 0.0167 |
| | resin | | acrylic resin | | dispersion | | | aqueous | | | | group | | | |
| | dispersion 2 | | dispersion 2 | | 1 | | | solution | | | | | | | |
| 4 | Polyester | 450 | Styrene | 50 | Colorant | 65 | 70 | 5 wt % borax | 140.0 | Boron | 4960 | Dodecyl | 1 | 197 | 0.0019 |
| | resin | | acrylic resin | | dispersion | | | aqueous | | | | group | | | |
| | dispersion 3 | | dispersion 2 | | 1 | | | solution | | | | | | | |
| 5 | Polyester | 450 | Styrene | 50 | Colorant | 65 | 70 | 5 wt % borax | 5.5 | Boron | 201 | Dodecyl | 1 | 5 | 0.0012 |
| | resin | | acrylic resin | | dispersion | | | aqueous | | | | group | | | |
| | dispersion 4 | | dispersion 2 | | 1 | | | solution | | | | | | | |
| 6 | Polyester | 450 | Styrene | 50 | Colorant | 65 | 70 | 5 wt % borax | 14.0 | Boron | 493 | Dodecyl | 1 | 3 | 0.0003 |
| | resin | | acrylic resin | | dispersion | | | aqueous | | | | group | | | |
| | dispersion 5 | | dispersion 2 | | 1 | | | solution | | | | | | | |
| 7 | Polyester | 450 | Styrene | 50 | Colorant | 65 | 70 | 5 wt % borax | 7.0 | Boron | 243 | Dodecyl | 1 | 496 | 0.0958 |
| | resin | | acrylic resin | | dispersion | | | aqueous | | | | group | | | |
| | dispersion 6 | | dispersion 2 | | 1 | | | solution | | | | | | | |
| 8 | Polyester | 450 | Styrene | 50 | Colorant | 65 | 70 | 5 wt % borax | 7.0 | Boron | 247 | Dodecyl | 1 | 620 | 0.1178 |
| | resin | | acrylic resin | | dispersion | | | aqueous | | | | group | | | |
| | dispersion 7 | | dispersion 2 | | 1 | | | solution | | | | | | | |
| 9 | Polyester | 450 | Styrene | 50 | Colorant | 65 | 70 | 5 wt % borax | 8.0 | Boron | 282 | n-octyl | 1 | 22 | 0.0048 |
| | resin | | acrylic resin | | dispersion | | | aqueous | | | | group | | | |
| | dispersion 8 | | dispersion 2 | | 1 | | | solution | | | | | | | |
| 10 | Polyester | 450 | Styrene | 50 | Colorant | 65 | 70 | 5 wt % borax | 8.0 | Boron | 279 | Ethyl- | 1 | 19 | 0.0042 |
| | resin | | acrylic resin | | dispersion | | | aqueous | | | | hexyl | | | |
| | dispersion 9 | | dispersion 2 | | 1 | | | solution | | | | group | | | |
| 11 | Polyester | 450 | Styrene | 50 | Colorant | 65 | 70 | 5 wt % borax | 8.0 | Boron | 280 | Decyl | 1 | 21 | 0.0040 |
| | resin | | acrylic resin | | dispersion | | | aqueous | | | | arouo | | | |
| | dispersion 10 | | dispersion 2 | | 1 | | | solution | | | | | | | |
| 12 | Polyester | 450 | Styrene | 50 | Colorant | 65 | 70 | 5 wt % borax | 8.0 | Boron | 276 | Tetradecyl | 1 | 20 | 0.0030 |
| | resin | | acrylic resin | | dispersion | | | aqueous | | | | group | | | |
| | dispersion 11 | | dispersion 2 | | 1 | | | solution | | | | | | | |
| 13 | Polyester | 450 | Styrene | 50 | Colorant | 65 | 70 | 5 wt % borax | 8.0 | Boron | 277 | Dodecyl | 1 | 22 | 0.0023 |
| | resin | | acrylic resin | | dispersion | | | aqueous | | | | group | | | |
| | dispersion 12 | | dispersion 2 | | 1 | | | solution | | | | | | | |
| 14 | Polyester | 450 | Styrene | 50 | Colorant | 65 | 70 | 5 wt % borax | 8.0 | Boron | 282 | Dodecyl | 3 | 19 | 0.0016 |
| | resin | | acrylic resin | | dispersion | | | aqueous | | | | group | | | |
| | dispersion 13 | | dispersion 2 | | 1 | | | solution | | | | | | | |
| 15 | Polyester | 450 | Styrene | 50 | Colorant | 65 | 70 | 10 wt % | 3.0 | Alumi- | 102 | Dodecyl | 1 | 16 | 0.0184 |
| | resin | | acrylic resin | | dispersion | | | Poly- | | num | | group | | | |
| | dispersion 1 | | dispersion 2 | | 1 | | | aluminum | | | | | | | |
| 16 | Polyester | 450 | Styrene | 50 | Colorant | 65 | 70 | 10 wt % | 30.0 | Mag- | 2120 | Dodecyl | 1 | 17 | 0.0008 |
| | resin | | acrylic resin | | dispersion | | | Magnesium | | nesium | | group | | | |
| | dispersion 1 | | dispersion 2 | | 1 | | | | | | | | | | |
| 17 | Polyester | 450 | Styrene | 50 | Colorant | 65 | 70 | 10 wt % | 10.0 | Calcium | 1711 | Dodecyl | 1 | 15 | 0.0015 |
| | resin | | acrylic resin | | dispersion | | | Calcium | | | | group | | | |
| | dispersion 1 | | dispersion 2 | | 1 | | | chloride | | | | | | | |
| 18 | Polyester | 450 | Styrene | 50 | Colorant | 65 | 70 | Polysilica | 15.0 | Iron | 1888 | Dodecyl | 1 | 17 | 0.0022 |
| | resin | | acrylic resin | | dispersion | | | iron | | | | group | | | |
| | dispersion 1 | | dispersion 2 | | 1 | | | (PSI-100) | | | | | | | |
| 19 | Polyester | 450 | Styrene | 50 | Colorant | 65 | 70 | 5 wt % borax | 8.0 | Boron | 281 | Dodecyl | 1 | 16 | 0.0027 |
| | resin | | acrylic resin | | dispersion | | | aqueous | | | | group | | | |
| | dispersion 14 | | dispersion 2 | | 1 | | | solution | | | | | | | |
| 20 | Styrene | 450 | Styrene | 50 | Colorant | 65 | 70 | 5 wt % borax | 8.0 | Boron | 286 | Dodecyl | 1 | 17 | 0.0028 |
| | acrylic resin | | acrylic resin | | dispersion | | | aqueous | | | | group | | | |
| | dispersion 1 | | dispersion 2 | | 1 | | | solution | | | | | | | |
| 21 | Polyester | 450 | Styrene | 50 | Colorant | 65 | 70 | 5 wt % borax | 8.0 | Boron | 282 | Dodecyl | 1 | 18 | 0.0030 |
| | resin | | acrylic resin | | dispersion | | | aqueous | | | | group | | | |
| | dispersion 1 | | dispersion 2 | | 2 | | | solution | | | | | | | |
| 22 | Polyester | 450 | Styrene | 50 | Colorant | 65 | 70 | 5 wt % borax | 8.0 | Boron | 280 | Dodecyl | 1 | 16 | 0.0027 |
| | resin | | acrylic resin | | dispersion | | | aqueous | | | | group | | | |
| | dispersion 1 | | dispersion 2 | | 3 | | | solution | | | | | | | |
| 23 | Polyester | 450 | Styrene | 50 | Colorant | 65 | 70 | 5 wt % borax | 8.0 | Boron | 283 | Dodecyl | 1 | 17 | 0.0028 |
| | resin | | acrylic resin | | dispersion | | | aqueous | | | | group | | | |
| | dispersion 1 | | dispersion 2 | | 4 | | | solution | | | | | | | |
| 24 | Polyester | 450 | Styrene | 50 | Colorant | 65 | 70 | 5 wt % borax | 8.0 | Boron | 2787 | — | — | — | — |
| | resin | | acrylic resin | | dispersion | | | aqueous | | | | | | | |
| | dispersion 15 | | dispersion 2 | | 1 | | | solution | | | | | | | |
| 25 | Polyester | 450 | Styrene | 50 | Colorant | 65 | 70 | 5 wt % borax | 2.5 | Boron | 91 | Dodecyl | 1 | 17 | 0.0088 |
| | resin | | acrylic resin | | dispersion | | | aqueous | | | | group | | | |
| | dispersion 1 | | dispersion 2 | | 1 | | | solution | | | | | | | |
| 26 | Polyester | 450 | Styrene | 50 | Colorant | 65 | 70 | 5 wt % borax | 140.0 | Boron | 5034 | Dodecyl | 1 | 16 | 0.0001 |
| | resin | | acrylic resin | | dispersion | | | aqueous | | | | group | | | |
| | dispersion 1 | | dispersion 2 | | 1 | | | solution | | | | | | | |
| 27 | Polyester | 450 | Styrene | 50 | Colorant | 65 | 70 | 5 wt % borax | 8.0 | Boron | 276 | n-butyl | 1 | 15 | 0.0050 |
| | resin | | acrylic resin | | dispersion | | | aqueous | | | | group | | | |
| | dispersion 16 | | dispersion 2 | | 1 | | | solution | | | | | | | |
| 28 | Polyester | 450 | Styrene | 50 | Colorant | 65 | 70 | 5 wt % borax | 8.0 | Boron | 278 | Dodecyl | 4 | 14 | 0.0015 |
| | resin | | acrylic resin | | dispersion | | | aqueous | | | | group | | | |
| | dispersion 17 | | dispersion 2 | | 1 | | | solution | | | | | | | |
| 29 | Polyester | 450 | Styrene | 50 | Colorant | 65 | 70 | 5 wt % borax | 8.0 | Boron | 279 | Octacosyl | 1 | 16 | 0.0014 |
| | resin | | acrylic resin | | dispersion | | | aqueous | | | | group | | | |
| | dispersion 18 | | dispersion 2 | | 1 | | | solution | | | | | | | |

In the table, the ppm of the constituent element denotes the content (ppm) of the respective polyvalent element in the toner. Further, (A/B) denotes the ratio (A/B) of the number of moles A of the compound represented by Formula (1) and the number of moles B of the polyvalent element, contained in the toner. In the table, R¹ and n of the compound represented by Formula (1) respectively denote R¹ and n of the compound represented by Formula (1). Further, the ppm of Formula (1) denotes the content (ppm) of the compound represented by Formula (1) in the toner. Polysilica iron (PSI-100) denotes polysilica iron (by Nankai Chemical Co., Ltd., product name: PSI-100).

### Examples 1 to 23 and Comparative Examples 1 to 6

The methods of the evaluations performed on Toners 1 to 29 are described below. Evaluation results are given in Table 3. A modified commercially available color laser printer (HP LaserJet Enterprise Color m553dn) was used in the evaluations. The color laser printer was modified so as to operate even with just one color process cartridge present in the printer. The printer was also modified so that the fixing unit could be altered to an arbitrary temperature. Toner was removed from the magenta toner cartridge, which was refilled with 150 g of each of Toners 1 to 20 and 24 to 29. Moreover, toner was removed from the cyan cartridge, which was refilled with 150 g of Toner 21. Further, toner was removed from the yellow cartridge, which was refilled with 150 g of Toner 22. Likewise, toner in the black cartridge was removed, and the cartridge was refilled with 150 g of Toner 23. Each refilled toner cartridge was attached to the printer station, dummy cartridges were attached to the other stations, and the following image output tests were carried out.

Evaluation of Gloss Unevenness

Solid-patch images having a size of 30 mm×30 mm at 9 sites on XEROX4200 paper (75 g/m²) by XEROX Corporation were outputted, the prints being outputted under conditions that included a heating unit set temperature of 170° C. and a process speed of 300 mm/sec. In terms of gloss unevenness, there was evaluated the difference between the maximum value and the minimum value from among the gloss values at the 9 sites in the image upon output of one print. Herein PG-3D (incidence angle) θ=75° by Nippon Denshoku Industries Co., Ltd.) was used as the gloss value measuring instrument, and black glass having a gloss value of 96.9 was used as a standard surface. The evaluation was carried out on the basis of the four rankings below according to the extent of the difference (gloss difference) between the maximum value and the minimum value among the gloss values.

A: gloss difference of smaller than 5

B: gloss difference of from 5 to less than 10

C: gloss difference of from 10 to less than 15

D: gloss difference of 15 or larger

Low-Temperature Fixability

A band-like unfixed image having a toner carrying amount of 0.5 mg/cm² was formed at the tip of XEROX4200 paper (75 g/m²) by XEROX Corporation, the process speed was set to 250 mm/s in a normal-temperature and normal-humidity environment (temperature 23° C., relative humidity 60%), and then the unfixed image was fixed, at respective temperatures, while the set temperature was sequentially raised in 5° C. increments, from 100° C. as the initial temperature.

The evaluation criteria of low-temperature fixability were as follows. A low-temperature-side fixing starting point denotes herein a lower-limit temperature at which a low-temperature offset phenomenon (phenomenon where part of the toner adheres to the fixing unit) is not observed. The evaluation was carried out according to the following 4 rankings, in accordance with the degree of the low-temperature-side fixing starting point.

A: low-temperature-side fixing starting point of lower than 140° C.

B: low-temperature-side fixing starting point of from 140° C. to less than 150° C.

C: low-temperature-side fixing starting point of from 150° C. to less than 160° C.

D: low-temperature-side fixing starting point of 160° C. or higher

Hot Offset Resistance

The fixation temperature was raised, and the highest temperature at which the offset phenomenon did not visually occur was taken as a hot-offset-free temperature, as an index of offset resistance. The evaluation was carried out according to the following 4 rankings, in accordance with the degree of the hot-offset-free temperature.

A: hot-offset-free temperature of 190° C. or higher

B: hot-offset-free temperature of from 180° C. to less than 190° C.

C: hot-offset-free temperature of from 170° C. to less than 180° C.

D: hot-offset-free temperature of lower than 170° C.

Blocking Resistance (Storage Stability)

Herein 10 g of each toner after the external addition treatment were placed in a polyethylene cup, the toner was allowed to stand for 3 days in an environment of 53° C., and was then evaluated according to the four rankings below depending on the degree of storage stability.

A: the toner collapses readily when tilted

B: lumps are present, but collapse readily when shaken

C: lumps are present that collapse readily, but without loosening up, when tilted.

D: the toner does not collapse even when tilted.

Evaluation of Durability Fogging (Developing Performance) in a High-Temperature and High-Humidity Environment

Fogging was evaluated in a high-temperature and high-humidity environment (30° C./80% RH). Herein XEROX4200 paper (75 g/m², by XEROX Corporation) was used as the evaluation paper. In a high-temperature and high-humidity environment, there were outputted 15,000 prints of intermittent durability printing in which 2 prints of an E character image having a print percentage of 1% were outputted every 4 seconds. A solid white image was outputted thereafter, and was evaluated. The measurement was performed using a reflection densitometer (REFLECTOMETER MODEL TC-6DS: by Tokyo Denshoku Co., Ltd.), taking Dr-Ds as a fogging value, where Ds is the worst value of the reflection density on a white background and Dr is the average reflection density of the transfer material prior to image formation. The smaller the fogging value, the better is the fogging level denoted thereby. The evaluation was carried out according to the following 4 rankings, in accordance with the degree of fogging.

A: the degree of fogging of lower than 0.5%

B: the degree of fogging of from 0.5% to less than 1.5%

C: the degree of fogging of from 1.5% to less than 3.0%

D: the degree of fogging of 3.0% or higher

TABLE 3

| | | | | Low- | | | | Blocking | HH | |
|---|---|---|---|---|---|---|---|---|---|---|
| | | Gloss | | temper- | | Hot | | resistance | fogging | |
| | | unevenness | | ature | | offset | | (stor- | (charge- | |
| | | | Gloss | fixability | | resistance | | ability) | ability) | |
| | Toner | Rank- | differ- | Rank- | | Rank- | | Rank- | Rank- | |
| | No. | ing | ence | ing | ° C. | ing | ° C. | ing | ing | % |
| Example 1 | Toner 1 | A | 2 | A | 130 | A | 190 | A | A | 0.2 |
| Example 2 | Toner 2 | C | 10 | A | 130 | A | 190 | C | A | 0.3 |
| Example 3 | Toner 3 | A | 3 | A | 130 | A | 190 | A | A | 0.4 |
| Example 4 | Toner 4 | C | 13 | C | 150 | A | 190 | B | B | 1.2 |
| Example 5 | Toner 5 | B | 9 | A | 135 | A | 190 | A | B | 1.0 |
| Example 6 | Toner 6 | C | 13 | A | 135 | B | 185 | A | B | 1.2 |
| Example 7 | Toner 7 | B | 9 | A | 130 | C | 170 | B | C | 1.5 |
| Example 8 | Toner 8 | C | 11 | A | 130 | C | 175 | C | C | 1.8 |
| Example 9 | Toner 9 | C | 12 | A | 130 | A | 190 | B | A | 0.4 |
| Example 10 | Toner 10 | C | 12 | A | 130 | A | 190 | B | A | 0.4 |
| Example 11 | Toner 11 | A | 4 | A | 130 | A | 190 | A | A | 0.3 |
| Example 12 | Toner 12 | A | 4 | A | 130 | A | 190 | A | A | 0.3 |
| Example 13 | Toner 13 | C | 12 | A | 135 | B | 180 | B | B | 1.3 |
| Example 14 | Toner 14 | C | 13 | A | 135 | C | 175 | C | C | 2.5 |
| Example 15 | Toner 15 | B | 8 | A | 135 | B | 185 | A | A | 0.4 |
| Example 16 | Toner 16 | C | 12 | A | 130 | B | 180 | B | B | 1.4 |
| Example 17 | Toner 17 | C | 13 | A | 130 | B | 180 | B | B | 1.4 |
| Example 18 | Toner 18 | B | 8 | A | 135 | B | 185 | A | A | 0.4 |
| Example 19 | Toner 19 | A | 4 | B | 145 | B | 180 | A | A | 0.4 |
| Example 20 | Toner 20 | B | 8 | B | 145 | C | 175 | A | A | 0.3 |
| Example 21 | Toner 21 | A | 3 | A | 130 | A | 190 | A | A | 0.3 |
| Example 22 | Toner 22 | A | 4 | A | 130 | A | 190 | A | A | 0.2 |
| Example 23 | Toner 23 | A | 2 | A | 130 | A | 190 | A | A | 0.4 |
| Comparative | Toner 24 | D | 17 | C | 155 | B | 180 | B | C | 2.0 |
| Example 1 | | | | | | | | | | |
| Comparative | Toner 25 | D | 16 | A | 130 | C | 170 | D | C | 2.4 |
| Example 2 | | | | | | | | | | |
| Comparative | Toner 26 | D | 18 | D | 160 | B | 180 | B | B | 1.3 |
| Example 3 | | | | | | | | | | |
| Comparative | Toner 27 | D | 18 | A | 130 | D | 165 | D | D | 3.2 |
| Example 4 | | | | | | | | | | |
| Comparative | Toner 28 | D | 20 | A | 135 | D | 165 | C | D | 3.0 |
| Example 5 | | | | | | | | | | |
| Comparative | Toner 29 | D | 20 | B | 145 | C | 175 | B | C | 1.8 |
| Example 6 | | | | | | | | | | |

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-096099 filed Jun. 8, 2021, and Japanese Patent Application No. 2022-010387 filed Jan. 26, 2022, which are hereby incorporated by reference herein in their entirety.

What is claimed is:

1. A toner comprising a toner particle comprising a binder resin,
wherein
the toner particle further comprises:
a compound represented by Formula (1) below:
R¹—[OCH₂CH₂]ₙ—OH (1)
where, in Formula (1), R¹ represents a linear or branched alkyl group having 8 to 22 carbon atoms, and n is an integer of 1 to 3; and
at least one polyvalent element selected from the group consisting of magnesium, calcium, aluminum, boron and iron, and
a content of the polyvalent element in the toner is 100 mass ppm to 5000 mass ppm.

2. The toner according to claim 1, wherein a content of the compound represented by Formula (1) in the toner is 5 mass ppm to 500 mass ppm.

3. The toner according to claim 1, wherein a ratio A/B of a number of moles A of the compound represented by Formula (1) and a number of moles B of the polyvalent element, comprised in the toner, is 0.0010 to 0.1000.

4. The toner according to claim 1, wherein the ratio A/B of the number of moles A of the compound represented by Formula (1) and the number of moles B of the polyvalent element, comprised in the toner, is 0.0010 to 0.0200.

5. The toner according to claim 1, wherein R¹ in the Formula (1) is a linear alkyl group having 12 to 22 carbon atoms.

6. The toner according to claim 1, wherein n in the Formula (1) is 1.

7. The toner according to claim 1, wherein the polyvalent element is at least one selected from the group consisting of aluminum, boron and iron.

8. The toner according to claim 1, wherein the polyvalent element is boron.

9. The toner according to claim 1, wherein the binder resin comprises a polyester resin.

10. The toner according to claim 9, wherein
the polyester resin is an amorphous polyester resin,
a content of the amorphous polyester resin in the binder resin is 50 mass % or higher, and
the amorphous polyester resin comprises a structural unit represented by Formula (2) in a content of 5.0 mass % or lower: 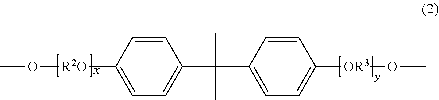
where, in the Formula (2), R² and R³ each independently represent an ethylene group or a propylene group; x and y each independently represent an average addition mole number of alkylene oxide; and a value of a sum of x and y is 1 to 5.

11. The toner according to claim 1, wherein
the toner comprises a crosslinked product of
ions comprising the polyvalent element, or ions generated from the polyvalent element, and
at least one selected from the group consisting of the compound represented by Formula (1) and the binder resin.
